(19) United States
(12) Patent Application Publication
(10) Pub. No.: US 2026/0359254 A1
(43) Pub. Date: Nov. 12, 2026

(54) Memory Card and Slot with Advanced Protocol and Shape Allowing Various Compatibility Options with Existing Memory Cards and Hosts

(71) Applicant: Sandisk Technologies, Inc., Milpitas, CA (US)

(72) Inventor: Yoseph Pinto, Tel Aviv (IL)

(73) Assignee: Sandisk Technologies, Inc., Milpitas, CA (US)

(21) Appl. No.: 19/570,855

(22) Filed: Mar. 18, 2026

Related U.S. Application Data
(60) Provisional application No. 63/802,875, filed on May 9, 2025.

(51) Int. Cl. G06F 13/42; G06K 7/00

(52) U.S. Cl. CPC G06F 13/4221; G06K 7/0056; G06F 2213/0026

(57) ABSTRACT

A new removable card form factor and its related card slot in a host are described herein. This card and slot can use an advanced protocol and have a shape that allows various compatibility options with existing memory cards and hosts. In one example, a memory card is presented comprising a change in shape or thickness of the legacy memory card in combination with connectors allowing protection of legacy memory hosts from the new memory cards insertion, while allowing smooth transition to the new memory card's host from legacy cards to the new card's hosts. In another example, an Express-type of memory card comprising a change in shape or thickness of the SD Express-type (microSD Express or SD Express) of card in combination with connectors allowing protection of legacy SD type (microSD and SD) hosts from Express-type cards insertion, while allowing smooth transition to the new Express-type host from SD Express card types to the Express-type hosts.

### CROSS-REFERENCE TO RELATED APPLICATION

This application claims priority to U.S. Provisional Patent Application No. 63/802,875, filed May 9, 2025, which is hereby incorporated by reference.

### BACKGROUND

MicroSD cards, which have an SD (UHS-I) interface, are very popular in the market. MicroSD Express cards, which have the same form factor (external shape, dimensions and thickness) as microSD cards but have a PCIe single lane, are now starting to be accepted by the market. Per the SD Association (SDA) Specification, any microSD Express card shall include, in addition to the PCIe interface, the SD (UHS-I) interface for backward compatibility. However, some hosts may only have a PCIe interface and not an SD (UHS-I) interface, as host manufacturers that take advantage of the high speeds offered by microSD Express cards may not see value in including the lower-speed SD interface. As such, these PCIe-only hosts support only microSD Express cards and not existing microSD cards.

### BRIEF DESCRIPTION OF THE DRAWINGS

FIG. 1 is a diagram comparing a microSD Express card with an Express Card of an embodiment.

FIG. 2 is a diagram illustrating different Express Card and slot designs of an embodiment.

FIG. 3 is a diagram illustrating a pin layout of a microSD Express card.

FIG. 4 is a diagram illustrating a pin layout of an Express Card of an embodiment.

FIG. 5 are illustrations of SD Express cards.

FIGS. 6-7 are illustrations of Express Cards of an embodiment.

### DETAILED DESCRIPTION

As mentioned above, microSD cards, which have an SD (UHS-I) interface, are very popular in the market. MicroSD Express cards, which have the same form factor as microSD cards but have a PCIe single lane, are now starting to be accepted by the market. Per the SD Association (SDA) Specification, any microSD Express card shall include, in addition to the PCIe interface, the SD (UHS-I) interface for backward compatibility. However, some hosts may only have a PCIe interface and not an SD (UHS-I) interface, as host manufacturers that take advantage of the high speeds offered by microSD Express cards may not see value in including the lower-speed SD interface. As such, these PCIe-only hosts will support only microSD Express cards and not existing microSD cards. This may not be a problem if a knowledgeable user is installing the card in the host, such as when the card is permanently installed in the host by a vendor as a semi-removable device (under cover) or if the cards are very clearly associated with a specific host. However, if the card is removable, it may be desirable to provide clear instructions informing consumers to use only microSD Express cards with the host.

On the memory card side, a memory card manufacturer may wish to remove the SD (UHS-I) interface from its microSD Express cards if the cards will be used in hosts that do not have an SD (UHS-I) interface. However, removal of the SD (UHS-I) interface from a microSD Express card is not allowed per the SDA Specification, and regardless of the specification, such removal might cause market confusion. For example, if a modified microSD Express card that supports only PCIe is inserted into a legacy microSD host, the card would not operate, thus causing confusion among consumers, who were promised to get backward compatibility of SD cards, from any type, at least to its basic SD protocol, and that would be difficult to control. Also, various licensing agreements may state that the microSD form factor shall include the SD (UHS-I) interface.

The following embodiments provide a new removable card form factor (referred to herein as an “Express Card”), in combination with a related card slot in a host, that may include one or two PCIe channels and be without an SD interface. (The smaller Express cards and related hosts are also referred to herein as “microExpress cards” and “microExpress hosts”). In one particular implementation (other implementations are possible), the shape of the card, its pads, and the connectors as characterized by one or more of the following:
(1) The Express Card has overall external dimensions of 11×15 mm, which are the same overall external dimensions of a microSD card, but the Express Card has a different shape than a microSD card.
(2) The Express Card has its own slot (i.e., a slot different from a slot for a microSD card) that supports at least one PCIe channel.
(3) The Express Card cannot be inserted/used in a legacy microSD card slot. In this way, the legacy microSD cards existing install-base is protected from any misusage of the new Express Card.
(4) The new host slot (the Express Card slot) may or may not accept existing microSD Express or microSD cards into its slot. That can be controlled by the shape of the card's connector.
(5) If the Express Card slot accepts microSD Express cards, it may operate the microSD Express card through its PCIe interface. If a standard microSD card is inserted, it will not operate, which is the same situation noted above with PCIe-only hosts.

In summary, this example embodiment introduces a new form factor that may support only PCIe and more than a single channel using similar dimensions to a microSD card without the SD interface, while protecting the legacy microSD card's existing install-base of hosts from misusage of the new card. This also allows continuation of usage of existing microSD Express cards in new hosts, which may not be the case if a totally different form factor is used.

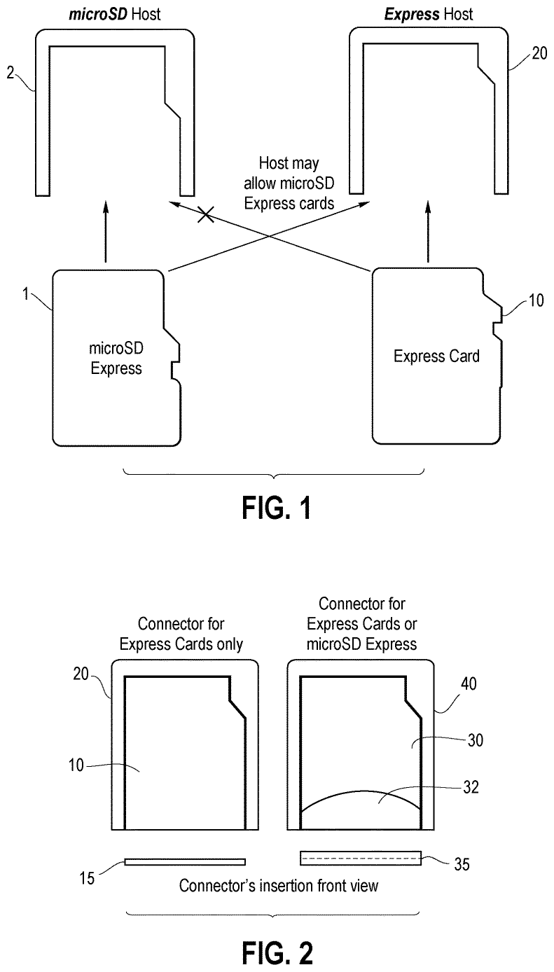

Turning now to the drawings, FIG. 1 is a diagram showing the interoperability of a microSD Express card 1 versus an Express Card 10 of an embodiment. As shown in this example, the Express Card 10 can fit in slots 2, 20 of both a microSD host and an Express host, but the microSD Express card 1 can only fit in the slot 2 of a microSD host (and not the slot 20 of an Express host). An Express host may choose to allow microSD Express insertion or not (e.g., if a given host supports Express cards, it may choose to also support older microSD Express cards).

In this embodiment, the dimensions of the Express Card 10 are 11×15 mm. The Express Card 10 has two PCIe Gen 4 channels and no SD interface. Also, as shown in FIG. 2, in some embodiments, the slot/connector 40 can be designed for Express Cards or for microSD Express cards. The connector 40 can accommodate a card 30 with a thumbnail ridge 32 that has a thicker front edge 35 than the front edge 15 of the Express Card 10 shown in FIG. 1. In some embodiments, the rear edge 15 of the Express Card 10 does not have a thicker end of 1.4 mm. So, the host may choose to use a connector with a housing that may accept the microSD with a thicker end or not. In some embodiments, the Express Card has a shorter narrow front, which prevents it from being inserted into legacy microSD hosts. In such a way the microSD market is protected from attempts of inserting the new Express card into it and avoid the mentioned potential confusion.

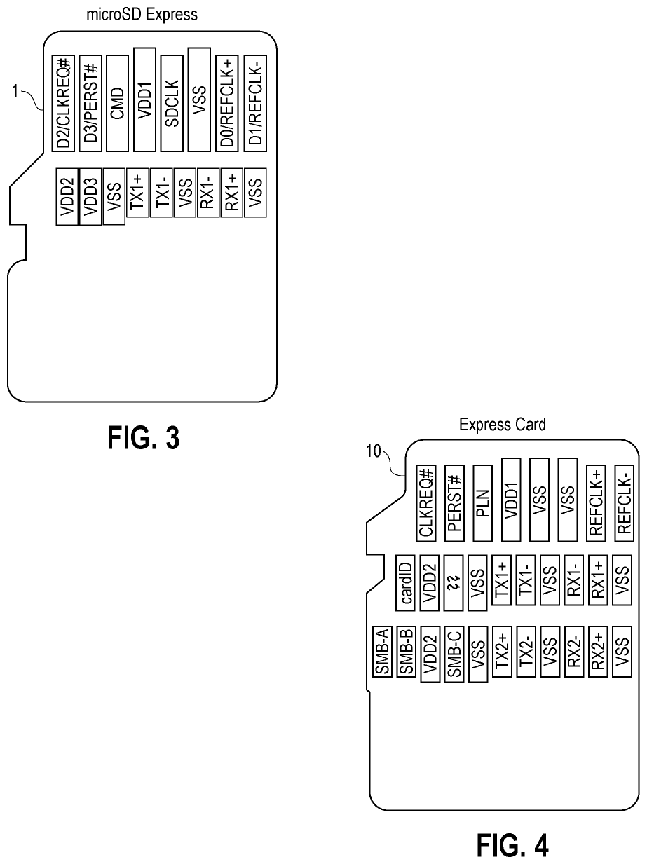

Turning now to FIGS. 3 and 4, FIG. 3 is a diagram illustrating a pin layout of a microSD Express card 1, and FIG. 4 is a diagram illustrating a pin layout of an Express Card 10 of an embodiment. The location of the voltage supply pads can be selected after considering the various supply voltages to the Express Card versus existing microSD Express cards. Also, the “cardID” pad may allow hardware detection of the Express Card, controlling the voltage supply or pin functionality or any other feature that requires a hardware based advanced detection of Express card usage.

These embodiments can also be applied to a full-size SD Express card without an SD interface. The Express Card discussed above will now be referred to as an “microExpress card” and a full-size SD card will be referred to as an “Express Card.” The concepts are similar in that both types of Express-type cards cannot be inserted into legacy microSD or SD slots, thereby protecting the legacy market. Also, the Express-type host, either microExpress host or Express host, may allow insertion of legacy microSD Express (or microSD) and SD Express (or standard SD) cards or may eliminate such insertion in a physical manner, respectively. Further, both solutions can be based on a combination of the change in the shape or thickness of the card along with a matching connector.

In one example implementation of the larger Express Card, that card and corresponding slot can be characterized by one or more of the following:
(1) Dimensions of 24×32 mm
(2) Up to 4× PCIe Gen 4 channels
(3) No SD interface
(4) An SD Express host that cannot accept an Express Card.
(5) An Express host may choose to allow SD Express insertion or not (allows future Express products to support older SD Express cards and the new Express cards).

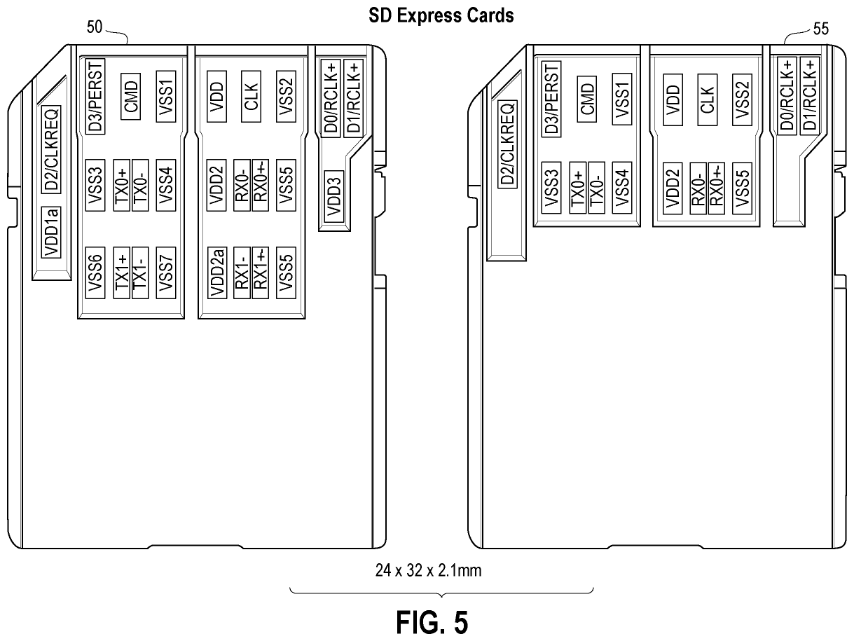

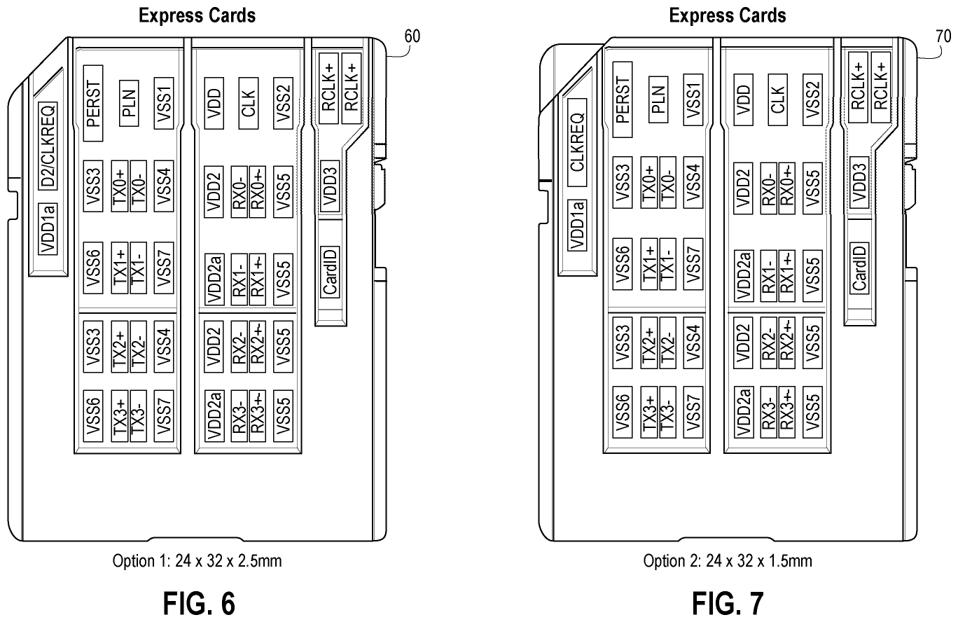

FIGS. 5 and 6 show pin layouts and sizes/shapes of an SD Express cards 50, 55 (FIG. 5) and Express Cards 60, 70 (FIG. 6). The “cardID” pad may allow hardware detection of the Express card, controlling the voltage supply or pin functionality.

Express cards 60 (FIGS. 6) and 70 (FIG. 7) shows two options for the Express card form factor-Option 1 is Card 60 with dimensions 24×32 mm with thickness greater than standard SD cards eg 2.5 mm. Option 2 is Card 70 with dimensions of 24×32 mm with thickness smaller than standard SD, eg 1.5 mm along with a shape of a full square. In option 1 the thickness of the Express card will not allow its insertion to standard SD host. In option 2 not having the corner cut in the Express card will not allow its full insertion to standard SD host.

Each of the options of the Express card features can resolve the same things: the Express card cannot be inserted into an SD Express host, and the SD Express card may be inserted to Express host. The difference is that with option 1, the host may not eliminate physical insertion of the SD Express card, while, with option 2, insertion may be allowed if the opening of the connector allows insertion of a card with thickness of at least 2.1 mm (thickness of SD cards).

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A memory card comprising:
a housing comprising external dimensions; and
a plurality of pads exposed on a bottom of the housing, wherein the plurality of pads are configured for a first interface;
wherein a shape of the housing is configured to prevent insertion of the memory card into a memory card slot that accepts another memory card having the same external dimensions as the memory card but with a different shape and with pads that are configured for a second interface and not the first interface.

2. The memory card of claim 1, wherein the first interface comprises a PCIe interface and the second interface comprises an SD interface.

3. The memory card of claim 2, wherein the PCIe interface comprises a single PCIe channel.

4. The memory card of claim 2, wherein the PCIe interface comprises a plurality of PCIe channels.

5. The memory card of claim 1, wherein the memory card further comprises pads configured for the second interface.

6. The memory card of claim 1, wherein the memory card does not comprise pads configured for the second interface.

7. The memory card of claim 1, wherein a notch located closer to a front of the memory card than a notch on the another memory card prevents insertion of the memory card into the memory card slot.

8. The memory card of claim 1, wherein the memory card comprises external dimensions of 24×32 mm.

9. The memory card of claim 8, wherein the memory card comprises a thickness of 2.5 mm.

10. The memory card of claim 8, wherein the memory card comprises a thickness of 1.5 mm.

11. The memory card of claim 1, wherein the memory card comprises external dimensions of 11×15 mm.

12. A host comprising:
a memory card slot shaped to accept insertion of a first type of memory card;
wherein:
the first type of memory card has same external dimensions as, but a different shape than, a second type of memory card;
the first type of memory card comprises pads configured for a first interface; and
the second type of memory card comprises pads configured for a second interface but not the first interface.

13. The host of claim 12, wherein the first interface comprises a PCIe interface and the second interface comprises an SD interface.

14. The host of claim 12, wherein the second type of memory card comprises a microSD card.

15. The host of claim 12, wherein the second type of memory card comprises an SD card.

16. The host of claim 12, wherein the first and second types of memory cards comprise respective notches, and wherein the first and second types of memory cards have different shapes due to different locations of the notches.

17. The host of claim 12, wherein the memory card slot is shaped to accept insertion of the second type of memory card.

18. The host of claim 17, wherein the second type of memory card comprises a thumbnail ridge, and wherein the memory card slot is shaped to accept insertion of the second type of memory card by accommodating the thumbnail ridge.

19. The host of claim 12, wherein the memory card slot is shaped to prevent insertion of the second type of memory card.

20. The host of claim 19, wherein the second type of memory card comprises a thumbnail ridge, and wherein the memory card slot is shaped to prevent insertion of the second type of memory card by not accommodating the thumbnail ridge.
